(19) United States
(12) Patent Application Publication
(10) Pub. No.: US 2016/0140769 A1
(43) Pub. Date: May 19, 2016

(54) EDGE-AWARE VOLUMETRIC DEPTH MAP FUSION

(71) Applicant: QUALCOMM Incorporated, San Diego, CA (US)

(72) Inventor: Gerhard REITMAYR, Vienna (AT)

(21) Appl. No.: 14/543,570

(22) Filed: Nov. 17, 2014

(51) Int. Cl. G06T 19/20; G06T 15/06; G06T 17/10

(52) U.S. Cl. CPC G06T 19/20; G06T 17/10; G06T 15/06; G06T 2200/04; G06T 2200/12

(57) ABSTRACT

Disclosed is a method and apparatus for reducing artifacts in a three-dimensional model of a surface reconstructed based on a plurality of range images. In one embodiment, the functions implemented include: detecting edges in one or more range images; computing a signed distance function for each range image; truncating the signed distance function to obtain a truncated signed distance function for each range image; and reducing a negative ramp length of the truncated signed distance function in one or more areas around the detected edges.

### FIELD

Embodiments of the invention are generally related to three-dimensional computer models of real-world objects. In particular, embodiments of the invention are related to methods for reducing artifacts in three-dimensional computer surface models based on range images.

### BACKGROUND

Curless et al., in “A Volumetric Method for Building Complex Models from Range Images,” Proceedings SIGGRAPH'96, pp. 303-312, incorporated herein by reference in its entirety, present a technique for reconstructing three-dimensional computer models of real-world surfaces by integrating groups of aligned range images. A range image includes depth values on a regular sampling lattice and is typically obtained by sweeping a 1D or 2D sensor linearly across an object or circularly around it. Range images themselves generally do not contain sufficient information to reconstruct the entire object.

This known technique employs a continuous implicit function, D(x), represented by samples. D(x), which is named a cumulative weighted signed distance function, represents the weighted signed distance of each point x to the nearest range surface along the line of sight to the sensor. The function is constructed by combining signed distance functions d1(x), d2(x) . . . dn(x) and weight functions w1(x), w2(x) . . . wn(x) obtained from range images 1 . . . n. The combination rules provide for each voxel a cumulative signed distance function, D(x), and a cumulative weight function W(x). According to the combination rules, the cumulative signed distance function D(x) is obtained using the equation

$$D ( x ) = \frac{\sum {w}_{i} ( x ) {d}_{i} ( x )}{\sum {w}_{i} ( x )} .$$

The functions are then represented on a discrete voxel grid, and an isosurface corresponding to D(x)=0 is extracted.

In principle, the distance and weight functions may extend indefinitely in either direction. However, to prevent surfaces on opposite sides of the object from interfering with each other, the known technique forces the weight function to taper off behind the surface. The known technique also utilizes a fixed point representation for the signed distance function which bounds the values to lie between a minimum, Dmin, and a maximum, Dmax. The bounded fixed point representation for the signed distance function is referred to as a truncated signed distance function (TSDF). The values of Dmin and Dmax are negative and positive, respectively, as they are on opposite sides of a signed distance zero-crossing. Hereinafter the absolute value of Dmin may be referred to as the negative ramp length, and the absolute value of Dmax may be referred to as the positive ramp length.

For three dimensions, the known technique for determining the signed distance functions and the weight functions for range images (i.e., computing the distance transforms of range images) may be summarized as follows: first, all voxel weights are set to zero, so that new data will overwrite the initial grid values. Next, each range image is tessellated by constructing triangles from nearest neighbors on the sampled lattice. Tessellation over step discontinuities is avoided by discarding triangles with edge lengths that exceed a reference threshold. A weight at each vertex is also computed.

Once a range image has been converted to a triangle mesh with a weight at each vertex, the voxel grid can be updated. The signed distance contribution is computed by casting a ray from the sensor through each voxel near the range surface and then intersecting it with the triangle mesh. The weight is computed by linearly interpolating the weights stored at the intersection triangle's vertices. Having determined the signed distance and weight functions of a range image as described above, the cumulative signed distance function and the cumulative weight function can be updated accordingly.

In another known method where depth maps are dense images, signed distance contribution at voxel locations can be updated by directly projecting the voxels into the depth map images and using the values at the pixel locations where the voxels hit, respectively, without constructing the triangle mesh.

Range images obtained from conventional camera/sensor systems including stereo, active, and time-of-flight (ToF) cameras have shadows at the edges of foreground objects because the camera/sensor systems cannot “see” around the corner at the edges of a foreground object. As the values close behind the range surface are represented with negative values in a TSDF, these shadows cause negative values to be created sideways beyond the edges. As a result, the reconstructed three-dimensional surface model, i.e., the isosurface corresponding to D(x)=0, may contain ringing artifacts.

### SUMMARY

An embodiment disclosed herein may include a method for reducing artifacts in a three-dimensional model of a surface reconstructed based on a plurality of range images, comprising: detecting edges in one or more range images; computing a signed distance function for each range image; truncating the signed distance function to obtain a truncated signed distance function for each range image; and reducing a negative ramp length of the truncated signed distance function in one or more areas around the detected edges.

Another embodiment disclosed herein may include an apparatus for reducing artifacts in a three-dimensional model of a surface reconstructed based on a plurality of range images, comprising: a memory; and a processor configured to: detect edges in one or more range images, compute a signed distance function for each range image, truncate the signed distance function to obtain a truncated signed distance function for each range image, and reduce a negative ramp length of the truncated signed distance function in one or more areas around the detected edges.

A further embodiment disclosed herein may include an apparatus for reducing artifacts in a three-dimensional model of a surface reconstructed based on a plurality of range images, comprising: means for detecting edges in one or more range images; means for computing a signed distance function for each range image; means for truncating the signed distance function to obtain a truncated signed distance function for each range image; and means for reducing a negative ramp length of the truncated signed distance function in one or more areas around the detected edges.

An additional embodiment disclosed herein may include a non-transitory computer-readable medium including code which, when executed by a processor, causes the processor to perform a method comprising: detecting edges in one or more range images; computing a signed distance function for each range image; truncating the signed distance function to obtain a truncated signed distance function for each range image; and reducing a negative ramp length of the truncated signed distance function in one or more areas around the detected edges.

### BRIEF DESCRIPTION OF THE DRAWINGS

FIG. 1 illustrates a known truncated signed distance function.

FIG. 2 illustrates a three-dimensional model of a surface reconstructed using the known technique.

FIG. 3 illustrates an exemplary device with which embodiments of the invention may be practiced.

FIG. 4 is a flowchart illustrating an exemplary method for reducing artifacts in three-dimensional computer surface models based on range images.

FIG. 5 illustrates an exemplary truncated signed distance function with the negative ramp length around an edge reduced.

FIG. 6 illustrates an exemplary range image with depth values encoded as gray levels.

FIG. 7 illustrates edges detected in a range image.

FIG. 8 illustrates an edge distance function with values encoded as gray levels.

FIG. 9 illustrates a truncated edge distance function with values encoded as gray levels.

### DETAILED DESCRIPTION

Embodiments of the invention are related to a method for reducing artifacts in three-dimensional computer surface models based on range images by removing false negative values in signed distance functions at the edges of foreground objects in range images. In one embodiment, the negative ramp length of a TSDF is reduced in areas close to edges.

As described above, there exists a known technique for reconstructing three-dimensional computer models of real-world surfaces by integrating groups of aligned range images. A range image includes depth values on a regular sampling lattice and is typically obtained by sweeping a 1D or 2D sensor linearly across an object or circularly around it. Range images themselves generally do not contain sufficient information to reconstruct the entire object.

This known technique employs a continuous implicit function, D(x), which is represented by samples. D(x), which is named a cumulative weighted signed distance function, represents the weighted signed distance of each point x to the nearest range surface along the line of sight to the sensor. The function is constructed by combining signed distance functions d1(x), d2(x) . . . dn(x) and weight functions w1(x), w2(x) . . . wn(x) obtained from range images 1 . . . n. The combination rules provide for each voxel a cumulative signed distance function, D(x), and a cumulative weight function W(x). According to the combination rules, the cumulative signed distance function D(x) is obtained using the formula

$$D ( x ) = \frac{\sum {w}_{i} ( x ) {d}_{i} ( x )}{\sum {w}_{i} ( x )}$$

The functions are then represented on a discrete voxel grid, and an isosurface corresponding to D(x)=0 is extracted.

To prevent surfaces on opposite sides of the object from interfering with each other, the known technique forces the weight function to taper off behind the surface. The known technique also utilizes a fixed point representation for the signed distance function which bounds the values to lie between a minimum, Dmin, and a maximum, Dmax. The bounded fixed point representation for the signed distance function is referred to as a truncated signed distance function (TSDF). The values of Dmin and Dmax are negative and positive, respectively, as they are on opposite sides of a signed distance zero-crossing. Hereinafter the absolute value of Dmin may be referred to as the negative ramp length, and the absolute value of Dmax may be referred to as the positive ramp length.

Range images obtained from conventional camera/sensor systems including stereo, active, and time-of-flight (ToF) cameras have shadows at the edges of foreground objects because the camera/sensor systems cannot “see” around the corners at the edges of foreground objects. As the values close behind the range surface are represented with negative values in a TSDF, these shadows cause negative values to be created sideways beyond the edges. As a result, the reconstructed three-dimensional surface model, i.e., the isosurface corresponding to D(x)=0, may contain ringing artifacts.

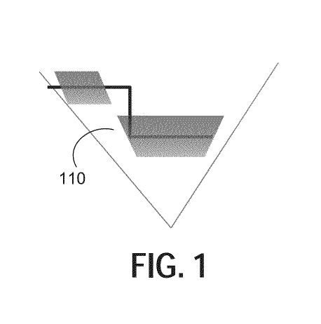

Referring to FIG. 1, an illustration of a known TSDF is shown. As can be seen in FIG. 1, there exists a shadow area 110 that correspond to negative values in the TSDF around a corner of an edge of a foreground object shown.

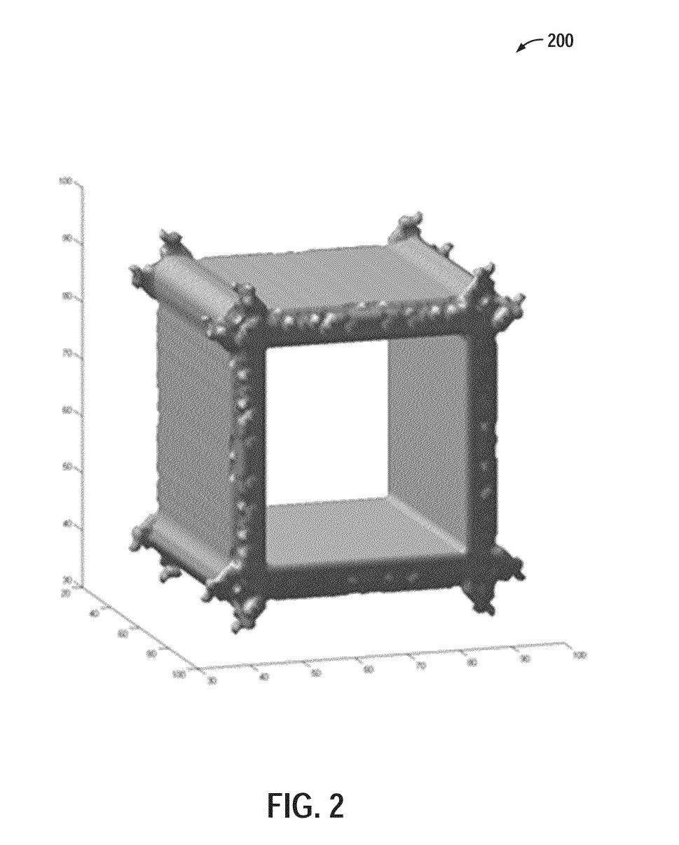

Referring to FIG. 2, an illustration of a three-dimensional model 200 of a surface reconstructed using the known technique is shown. Ringing artifacts can be easily seen near the edges of the object surface depicted.

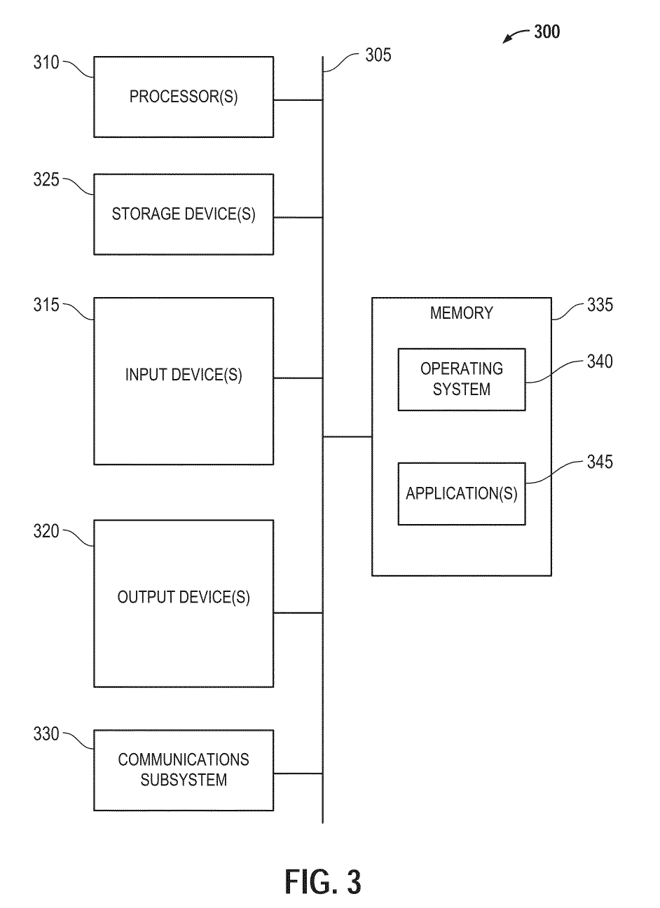

An example device 300 adapted for reconstructing three-dimensional models of surfaces based on range images is illustrated in FIG. 3. The device as used herein (e.g., device 300) may be a: mobile device, wireless device, cell phone, personal digital assistant, mobile computer, wearable device (e.g., watch, head mounted display, virtual reality glasses, etc.), tablet, personal computer, laptop computer, or any type of device that has processing capabilities. As used herein, a mobile device may be any portable, or movable device or machine that is configurable to acquire wireless signals transmitted from, and transmit wireless signals to, one or more wireless communication devices or networks. Thus, by way of example but not limitation, the device 300 may include a radio device, a cellular telephone device, a computing device, a personal communication system device, or other like movable wireless communication equipped device, appliance, or machine.

The device 300 is shown comprising hardware elements that can be electrically coupled via a bus 305 (or may otherwise be in communication, as appropriate). The hardware elements may include one or more processors 310, including without limitation one or more general-purpose processors and/or one or more special-purpose processors (such as digital signal processing chips, graphics acceleration processors, and/or the like); one or more input devices 315, which include without limitation a mouse, a keyboard, keypad, touch-screen, camera, microphone and/or the like; and one or more output devices 320, which include without limitation a display device, a speaker, a printer, and/or the like.

The device 300 may further include (and/or be in communication with) one or more non-transitory storage devices 325, which can comprise, without limitation, local and/or network accessible storage, and/or can include, without limitation, a disk drive, a drive array, an optical storage device, solid-state storage device such as a random access memory (“RAM”) and/or a read-only memory (“ROM”), which can be programmable, flash-updateable, and/or the like. Such storage devices may be configured to implement any appropriate data stores, including without limitation, various file systems, database structures, and/or the like.

The device may also include a communication subsystem 330, which can include without limitation a modem, a network card (wireless or wired), an infrared communication device, a wireless communication device and/or chipset (such as a Bluetooth device, an 802.11 device, a Wi-Fi device, a WiMAX device, cellular communication facilities, etc.), and/or the like. The communications subsystem 330 may permit data to be exchanged with a network, other devices, and/or any other devices described herein. In one embodiment, the device 300 may further comprise a memory 335, which can include a RAM or ROM device, as described above. It should be appreciated that device 300 may be a mobile device or a non-mobile device, and may have wireless and/or wired connections.

The device 300 may also comprise software elements, shown as being currently located within the working memory 335, including an operating system 340, device drivers, executable libraries, and/or other code, such as one or more application programs 345, which may comprise or may be designed to implement methods, and/or configure systems, provided by embodiments, as will be described herein. Merely by way of example, one or more procedures described with respect to the method(s) discussed below might be implemented as code and/or instructions executable by device 300 (and/or a processor 310 within device 300); in an aspect, then, such code and/or instructions can be used to configure and/or adapt a general purpose computer (or other device) to perform one or more operations in accordance with the described methods.

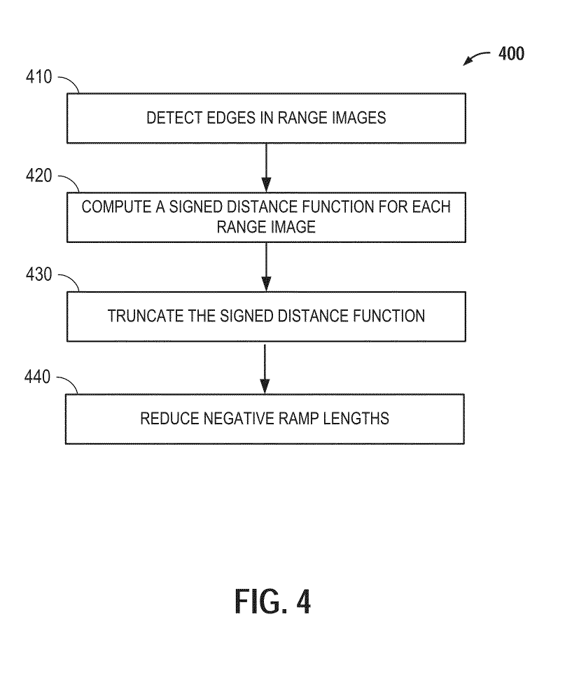

A set of these instructions and/or code might be stored on a non-transitory computer-readable storage medium, such as the storage device(s) 325 described above. In some cases, the storage medium might be incorporated within a device, such as the device 300. In other embodiments, the storage medium might be separate from a device (e.g., a removable medium, such as a compact disc), and/or provided in an installation package, such that the storage medium can be used to program, configure, and/or adapt a general purpose computer with the instructions/code stored thereon. These instructions might take the form of executable code, which is executable by the computerized device 300 and/or might take the form of source and/or installable code, which, upon compilation and/or installation on the device 300 (e.g., using any of a variety of generally available compilers, installation programs, compression/decompression utilities, etc.), then takes the form of executable code. For example, instructions for implementing a method similar to method 400 of FIG. 4 may be stored in storage device(s) 325 and maybe retrieved by processor(s) 310. By executing the instructions, the processor(s) 310 performs method 400. Application programs 345 can include such instructions.

Application programs 345 may include one or more applications for reconstructing three-dimensional models of surfaces based on range images. It should be appreciated that the functionality of the applications for reconstructing three-dimensional models of surfaces based on range images described hereinafter may be alternatively implemented in hardware or different levels of software, such as an operating system (OS), a firmware, a computer vision module, etc.

The device 300 for reducing or eliminating artifacts in a three-dimensional model of a surface reconstructed based on a plurality of range images may comprise a memory 335 and a processor 310 configured to: detect edges in one or more range images, compute a signed distance function for each range image, truncate the signed distance function to obtain a truncated signed distance function for each range image, and reduce one or more negative ramp lengths of the truncated signed distance function in one or more areas around the detected edges.

Embodiments Referring to FIG. 4, a flowchart illustrating an exemplary method 400 operable on device 300 for reducing artifacts in three-dimensional computer surface models based on range images by removing false negative values in signed distance functions at the edges of foreground objects in range images. At block 410, edges in a range image may be detected. Any method may be used for detecting the edges in an exemplary range image. For example, the edges may be detected by looking for areas without depth values and areas where depth discontinuities occur. In some embodiments, an edge distance function may be generated for each range image, where the edge distance function encodes for each pixel the distance between the pixel and the closest edge. Next, at block 420, a signed distance function may be computed for the range image using known techniques. A weight function may also be computed for the range image. Thereafter, at block 430, the signed distance function may be truncated using known techniques. Truncating the signed distance function may include, for example, bounding the signed distance function with a positive maximum, Dmax, and a negative minimum, Dmin. As described above, the absolute value of Dmax may be referred to as the positive ramp length, and the absolute value of Dmin may be referred to as the negative ramp length. The negative ramp length may be, for example, 20 pixels. Last, at block 440, the negative ramp length of the truncated signed distance function may be reduced in areas of the range image that are close to an edge compared to the value of the negative ramp length prior to reduction and after computing and truncating the signed distance function for each range image. In some embodiments, the closer an area is close to an edge, the more the negative ramp length is reduced. This may be achieved by, for example, using the edge distance function described above. In other words, in some embodiments, the reducing of the negative ramp length may be based on the edge distance function.

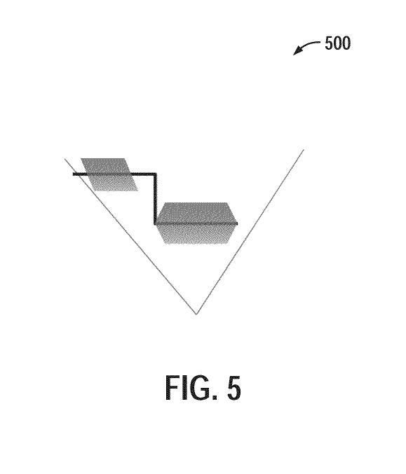

Referring to FIG. 5, an illustration of an exemplary truncated signed distance function 500 with the negative ramp length around an edge reduced is shown. The truncated signed distance function 500 of FIG. 5 corresponds to the same range image as the TSDF shown in FIG. 1, except that in the area corresponding to the shadow area 110 of FIG. 1, negative values are removed or reduced as a result of the reduced negative ramp length around the edge.

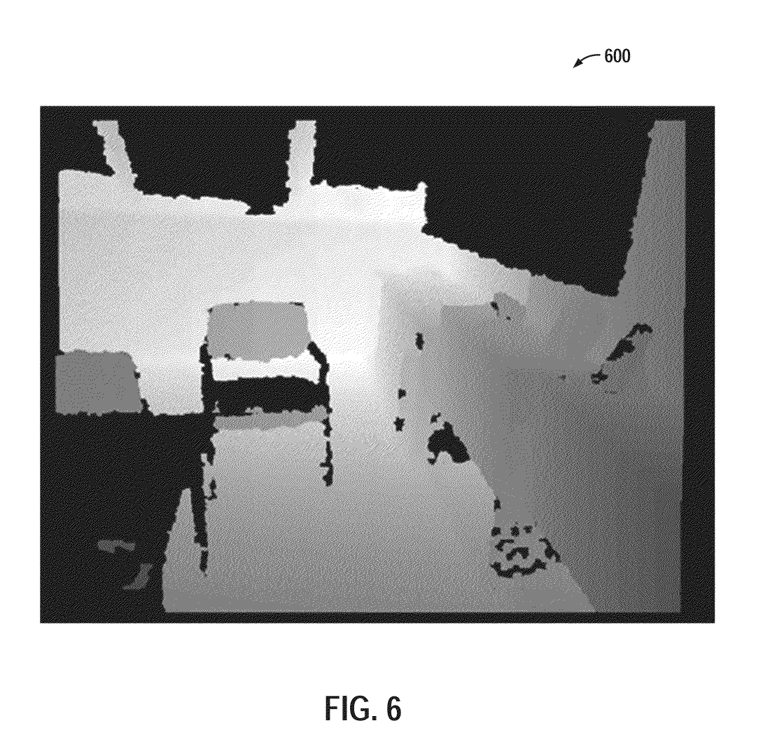

Referring to FIG. 6, an illustration of an exemplary range image 600 with depth values encoded as gray levels is shown. In FIG. 6, brighter values correspond to larger depth values, and the black color indicates an absence of depth values.

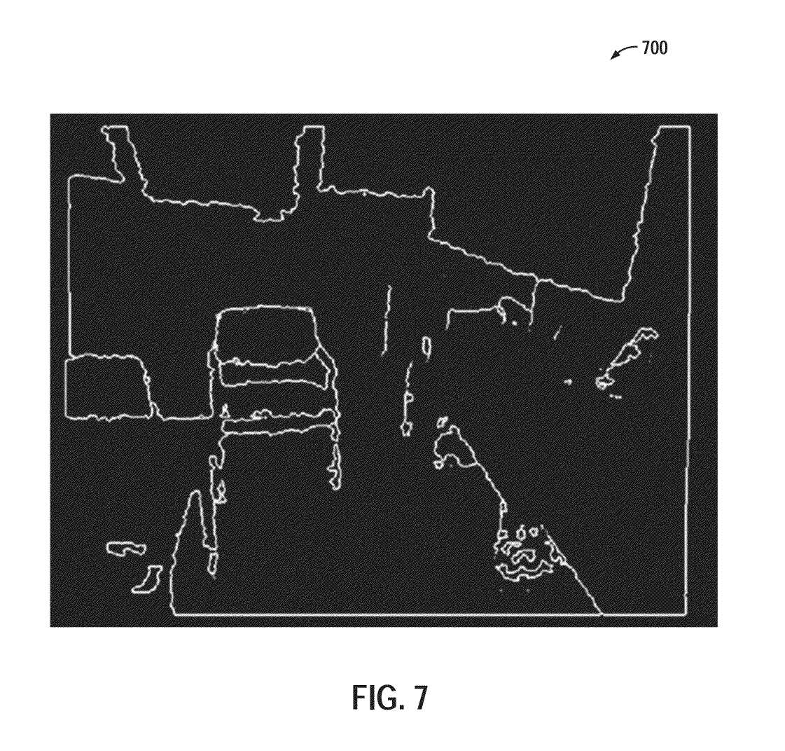

Referring to FIG. 7, an illustration 700 of edges detected in the range image 600 is shown. Detecting edges in a range image is described above with reference to block 410 of FIG. 4. Any method may be used for detecting the edges in an exemplary range image. For example, the edges may be detected by looking for areas without depth values and areas where depth discontinuities occur. The edges in the range image 600 are shown as white pixels in FIG. 7 and correspond to abrupt depth discontinuities.

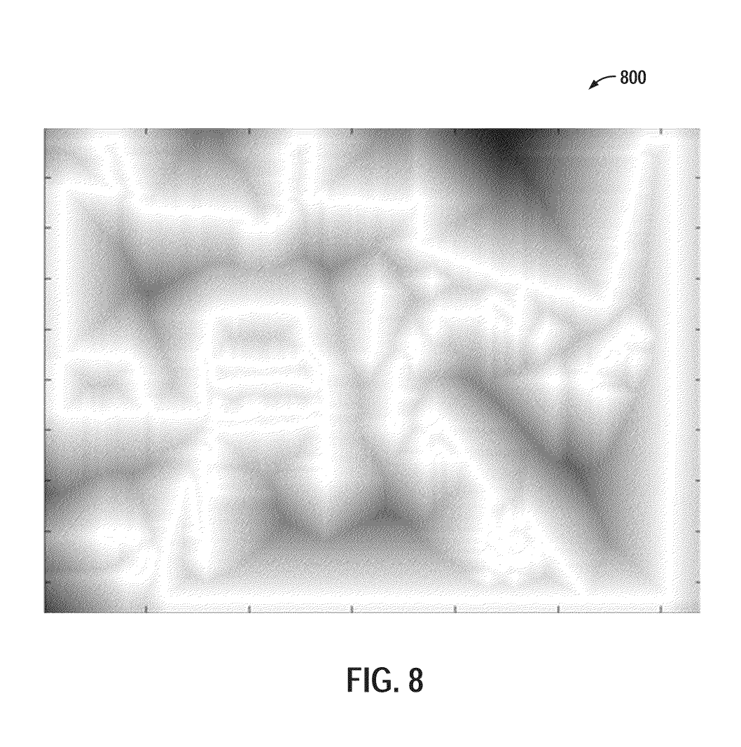

Referring to FIG. 8, an illustration of an edge distance function 800 corresponding to the range image 600 of FIG. 6 with values encoded as gray levels is shown. As can be seen in FIG. 8, darker values correspond to areas further away from the edges.

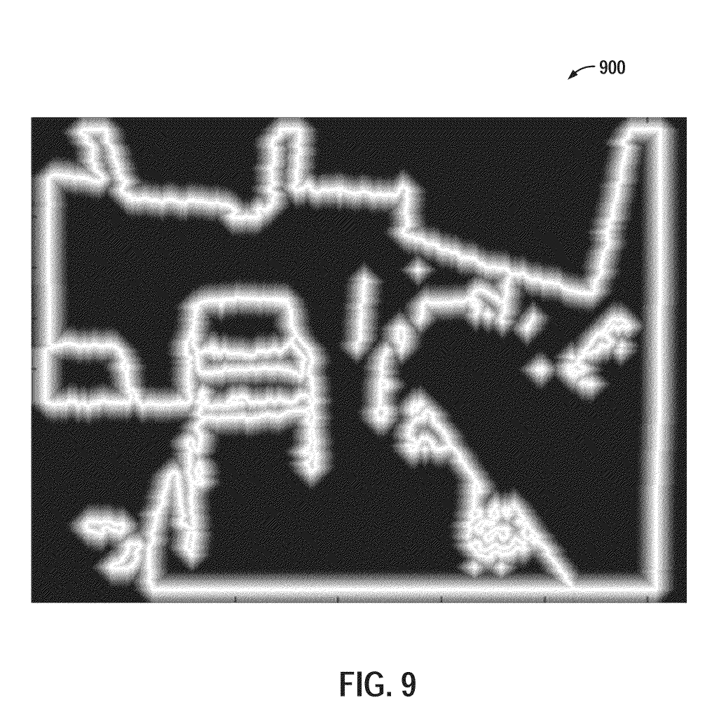

Referring to FIG. 9, an illustration of a truncated edge distance function 900 corresponding to the range image 600 of FIG. 6 with values encoded as gray levels is shown. Here, both the positive ramp length and the negative ramp length are set to 20 pixels. Therefore, values corresponding to pixels further than 20 pixels away from the edges are truncated (i.e., they are encoded as black in FIG. 9). The signed distance function is therefore tapered off in a band (in this example, a band of 20 pixels) around the detected edges, not everywhere in the image. The dark areas illustrated in FIG. 9 represent regions where the signed distance function is left unchanged. The signed distance function, illustrated in FIG. 5 as trapezoids, is only modified for pixels that are in grey-to-white areas illustrated in FIG. 9.

Therefore, utilizing embodiments of invention described herein, negative values around edges in truncated signed distance functions corresponding to range images may be removed or reduced, and as a result, artifacts, such as ringing artifacts, in three-dimensional models of surfaces reconstructed based on the range images may be reduced or eliminated.

Various implementations of an application or system that reduces or eliminates artifacts in three-dimensional models of surfaces reconstructed based on range images have been previously described in detail. It should be appreciated that application or system that reduces or eliminates artifacts in three-dimensional models of surfaces reconstructed based on range images, as previously described, may be implemented as software, firmware, hardware, combinations thereof, etc. In one embodiment, the previous described functions may be implemented by one or more processors (e.g., processor 310) of a device 300 to achieve the previously desired functions (e.g., the method operations of FIG. 4). Artifacts in three-dimensional models of surfaces reconstructed based on range images may be reduced or eliminated by removing or reducing negative values around edges in truncated signed distance functions corresponding to the range images.

The teachings herein may be incorporated into (e.g., implemented within or performed by) a variety of apparatuses (e.g., devices). For example, one or more aspects taught herein may be incorporated into a general device, a desktop computer, a mobile computer, a mobile device, a phone (e.g., a cellular phone), a personal data assistant, a tablet, a laptop computer, a tablet, an entertainment device (e.g., a music or video device), a headset (e.g., headphones, an earpiece, etc.), a medical device (e.g., a biometric sensor, a heart rate monitor, a pedometer, an EKG device, etc.), a user I/O device, a computer, a server, a point-of-sale device, an entertainment device, a set-top box, a wearable device (e.g., watch, head mounted display, virtual reality glasses, etc.), an electronic device within an automobile, or any other suitable device.

In some aspects a wireless device may comprise an access device (e.g., a Wi-Fi access point) for a communication system. Such an access device may provide, for example, connectivity to another network through transceiver (e.g., a wide area network such as the Internet or a cellular network) via a wired or wireless communication link. Accordingly, the access device may enable another device (e.g., a Wi-Fi station) to access the other network or some other functionality. In addition, it should be appreciated that one or both of the devices may be portable or, in some cases, relatively non-portable.

It should be appreciated that when the devices are mobile or wireless devices that they may communicate via one or more wireless communication links through a wireless network that are based on or otherwise support any suitable wireless communication technology. For example, in some aspects the wireless device and other devices may associate with a network including a wireless network. In some aspects the network may comprise a body area network or a personal area network (e.g., an ultra-wideband network). In some aspects the network may comprise a local area network or a wide area network. A wireless device may support or otherwise use one or more of a variety of wireless communication technologies, protocols, or standards such as, for example, 3G, LTE, Advanced LTE, 4G, CDMA, TDMA, OFDM, OFDMA, WiMAX, and WiFi. Similarly, a wireless device may support or otherwise use one or more of a variety of corresponding modulation or multiplexing schemes. A wireless device may thus include appropriate components (e.g., air interfaces) to establish and communicate via one or more wireless communication links using the above or other wireless communication technologies. For example, a device may comprise a wireless transceiver with associated transmitter and receiver components (e.g., a transmitter and a receiver) that may include various components (e.g., signal generators and signal processors) that facilitate communication over a wireless medium. As is well known, a mobile wireless device may therefore wirelessly communicate with other mobile devices, cell phones, other wired and wireless computers, Internet web-sites, etc.

Those of skill in the art would understand that information and signals may be represented using any of a variety of different technologies and techniques. For example, data, instructions, commands, information, signals, bits, symbols, and chips that may be referenced throughout the above description may be represented by voltages, currents, electromagnetic waves, magnetic fields or particles, optical fields or particles, or any combination thereof.

Those of skill in the art would further appreciate that the various illustrative logical blocks, modules, engines, circuits, and algorithm steps described in connection with the embodiments disclosed herein may be implemented as electronic hardware, computer software, or combinations of both. To clearly illustrate this interchangeability of hardware and software, various illustrative components, blocks, modules, engines, circuits, and steps have been described above generally in terms of their functionality. Whether such functionality is implemented as hardware or software depends upon the particular application and design constraints imposed on the overall system. Skilled artisans may implement the described functionality in varying ways for each particular application, but such implementation decisions should not be interpreted as causing a departure from the scope of the present invention.

The various illustrative logical blocks, modules, and circuits described in connection with the embodiments disclosed herein may be implemented or performed with a general purpose processor, a digital signal processor (DSP), an application specific integrated circuit (ASIC), a field programmable gate array (FPGA) or other programmable logic device, discrete gate or transistor logic, discrete hardware components, or any combination thereof designed to perform the functions described herein. A general-purpose processor may be a microprocessor, but in the alternative, the processor may be any conventional processor, controller, microcontroller, or state machine. A processor may also be implemented as a combination of computing devices, e.g., a combination of a DSP and a microprocessor, a plurality of microprocessors, one or more microprocessors in conjunction with a DSP core, or any other such configuration.

The steps of a method or algorithm described in connection with the embodiments disclosed herein may be embodied directly in hardware, in a software module executed by a processor, or in a combination of the two. A software module may reside in RAM memory, flash memory, ROM memory, EPROM memory, EEPROM memory, registers, hard disk, a removable disk, a CD-ROM, or any other form of storage medium known in the art. An exemplary storage medium is coupled to the processor such the processor can read information from, and write information to, the storage medium. In the alternative, the storage medium may be integral to the processor. The processor and the storage medium may reside in an ASIC. The ASIC may reside in a user terminal. In the alternative, the processor and the storage medium may reside as discrete components in a user terminal.

In one or more exemplary embodiments, the functions described may be implemented in hardware, software, firmware, or any combination thereof. If implemented in software as a computer program product, the functions or modules may be stored on or transmitted over as one or more instructions or code on a non-transitory computer-readable medium. Computer-readable media can include both computer storage media and communication media including any medium that facilitates transfer of a computer program from one place to another. A storage media may be any available media that can be accessed by a computer. By way of example, and not limitation, such non-transitory computer-readable media can comprise RAM, ROM, EEPROM, CD-ROM or other optical disk storage, magnetic disk storage or other magnetic storage devices, or any other medium that can be used to carry or store desired program code in the form of instructions or data structures and that can be accessed by a computer. Also, any connection is properly termed a computer-readable medium. For example, if the software is transmitted from a web site, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of medium. Disk and disc, as used herein, includes compact disc (CD), laser disc, optical disc, digital versatile disc (DVD), floppy disk and blu-ray disc where disks usually reproduce data magnetically, while discs reproduce data optically with lasers. Combinations of the above should also be included within the scope of non-transitory computer-readable media.

The previous description of the disclosed embodiments is provided to enable any person skilled in the art to make or use the present invention. Various modifications to these embodiments will be readily apparent to those skilled in the art, and the generic principles defined herein may be applied to other embodiments without departing from the spirit or scope of the invention. Thus, the present invention is not intended to be limited to the embodiments shown herein but is to be accorded the widest scope consistent with the principles and novel features disclosed herein.

What is claimed is:

1. A method for reducing artifacts in a three-dimensional model of a surface reconstructed based on a plurality of range images, comprising:
detecting edges in one or more range images;
computing a signed distance function for each range image;
truncating the signed distance function to obtain a truncated signed distance function for each range image; and
reducing a negative ramp length of the truncated signed distance function in one or more areas around the detected edges.

2. The method of claim 1, wherein the edges are detected by looking for areas without depth values or areas where depth discontinuities occur.

3. The method of claim 1, wherein the truncating of the signed distance function further comprises bounding the signed distance function with a positive maximum and a negative minimum.

4. The method of claim 1, wherein the negative ramp lengths are reduced more in areas closer to the detected edges.

5. The method of claim 1, further comprising reconstructing a three-dimensional model of a surface based on the signed distance functions for the range images.

6. The method of claim 1, further comprising generating an edge distance function for each range image, the edge distance function encoding distances between pixels and edges closest to the pixels, wherein the reducing of the negative ramp length is based on the edge distance function.

7. An apparatus for reducing artifacts in a three-dimensional model of a surface reconstructed based on a plurality of range images, comprising:
a memory; and
a processor configured to:
detect edges in one or more range images,
compute a signed distance function for each range image,
truncate the signed distance function to obtain a truncated signed distance function for each range image, and
reduce a negative ramp length of the truncated signed distance function in one or more areas around the detected edges.

8. The apparatus of claim 7, wherein the edges are detected by looking for areas without depth values or areas where depth discontinuities occur.

9. The apparatus of claim 7, wherein the processor configured to truncate the signed distance function is further configured to bound the signed distance function with a positive maximum and a negative minimum.

10. The apparatus of claim 7, wherein the negative ramp lengths are reduced more in areas closer to the detected edges.

11. The apparatus of claim 7, wherein the processor is further configured to reconstruct a three-dimensional model of a surface based on the signed distance functions for the range images.

12. The apparatus of claim 7, wherein the processor is further configured to generate an edge distance function for each range image, the edge distance function encoding distances between pixels and edges closest to the pixels, wherein the reducing of the negative ramp length is based on the edge distance function.

13. An apparatus for reducing artifacts in a three-dimensional model of a surface reconstructed based on a plurality of range images, comprising:
means for detecting edges in one or more range images;
means for computing a signed distance function for each range image;
means for truncating the signed distance function to obtain a truncated signed distance function for each range image; and
means for reducing a negative ramp length of the truncated signed distance function in one or more areas around the detected edges.

14. The apparatus of claim 13, wherein the edges are detected by looking for areas without depth values or areas where depth discontinuities occur.

15. The apparatus of claim 13, wherein the means for truncating of the signed distance function further comprises means for bounding the signed distance function with a positive maximum and a negative minimum.

16. The apparatus of claim 13, wherein the negative ramp lengths are reduced more in areas closer to the detected edges.

17. The apparatus of claim 13, further comprising means for reconstructing a three-dimensional model of a surface based on the signed distance functions for the range images.

18. The apparatus of claim 13, further comprising means for generating an edge distance function for each range image, the edge distance function encoding distances between pixels and edges closest to the pixels, wherein the reducing of the negative ramp length is based on the edge distance function.

19. A non-transitory computer-readable medium including code which, when executed by a processor, the processor performs a method comprising:
detecting edges in one or more range images;
computing a signed distance function for each range image;
truncating the signed distance function to obtain a truncated signed distance function for each range image; and
reducing a negative ramp length of the truncated signed distance function in one or more areas around the detected edges.

20. The non-transitory computer-readable medium of claim 19, wherein the edges are detected by looking for areas without depth values or areas where depth discontinuities occur.

21. The non-transitory computer-readable medium of claim 19, wherein the truncating of the signed distance function comprises bounding the signed distance function with a positive maximum and a negative minimum.

22. The non-transitory computer-readable medium of claim 19, wherein the negative ramp lengths are reduced more in areas closer to the detected edges.

23. The non-transitory computer-readable medium of claim 19, the method further comprising reconstructing a three-dimensional model of a surface based on the signed distance functions for the range images.

24. The non-transitory computer-readable medium of claim 19, the method further comprising generating an edge distance function for each range image, the edge distance function encoding distances between pixels and edges closest to the pixels, wherein the reducing of the negative ramp length is based on the edge distance function.
